(19) United States
(12) Patent Application Publication
(10) Pub. No.: US 2003/0088622 A1
(43) Pub. Date: May 8, 2003

(54) Efficient and robust adaptive algorithm for silence detection in real-time conferencing

(76) Inventors: Jenq-Neng Hwang, Bellevue, WA (US); Yen-Hao Tseng, Woodinville, WA (US)

Correspondence Address: Jenq-Neng Hwang, 18005 N.E. 68th St., Suite A101, Redmond, WA, 98052, US

(21) Appl. No.: 10/014,133

(22) Filed: Nov. 4, 2001

(51) Int. Cl. G06F 15/16; H04N 7/14

(52) U.S. Cl. 709/204; 348/14.08

(57) ABSTRACT

HomeMeeting Inc. provides complete Internet service (www.homemeeting.com) for multipoint multimedia IP-communication network. To the best of our knowledge, this is the first attempt of fully Internet-based interactive multipoint multimedia WAN communication service with enhanced quality of service (QoS) and a complete suite of presentation/discussion functionalities over narrowband (as low as 26.4 Kbps) connections. Every registered member of this service can sign into the Member Meeting Center from HomeMeeting's website, schedule meeting, invite meeting participants, and pre-upload documents for online discussion. To avoid the need of multiple microphone requirement which is feasible for most low-end audio/video conferencing terminals, and to avoid the need of using very complex signal processing algorithms which call for higher computational needs and longer voice delay, in this invention, a low complexity and effective silence detection technique based on an intelligent determination of adaptive threshold value is proposed to enable real-time audio/video conferencing.

### REFERENCES

[1] K. Bullington, J. M. Fraser, “Engineering Aspect of Time Assigned Speech Interpolation (TASI),” Bell System Technical Journal (BSTJ), vol. 38, pp. 353-364, 1959.

[2] M. Rangoussi, A. Delopoulos, M. Tsatsanis, “On the Use of Higher Order Statistics for Robust Endpoint Detection of Speech,” pp. 56-60, IEEE Signal Processing Workshop on Higher-Order Statistics, South Lake Tahoe, Calif., 1993.

[3] L. Rabiner, M. Sambur, “An Algorithm for Determining the Endpoints of Isolated Utterance,” Bell System Technical Journal (BSTJ), vol. 54, pp. 297-315, 1975.

[4] ITU-T, G.729 Annex B, “A Silence Compression Scheme for G.729 Optimized for Terminal Conforming to Recommendation V.70,” October 1996. http://www.itu.int/re/recommendation.asp?type=items&lang=e&parent=T-REC-G.729-199610-I!AnnB

[5] IC-Tech. Inc., “Enhanced Silence Detection in Variable Rate Coding Systems using Voice Extraction,” White paper, April 2000, http://www.ic-tech.com/pdf_docs/bandwidthwhitepaper.pdf

### TECHNICAL FIELD

This invention proposes a low complexity and effective silence detection technique based on an intelligent determination of adaptive threshold value to enable real-time audio/video conferencing.

### BACKGROUND OF THE INVENTION

Thanks to the recent advances in audio/video compression, processor design, and communication network architecture, it is now quite feasible to implement multimedia communication applications (e.g., audio/video conferencing) using standard computing and networking facilities. This shift of multimedia communication equipment and services from dedicated systems to general purpose computers and packet-based communication networks has introduced a quite different operating environment and has prompted the reexamination of several key algorithms. Silence detection and removal is an essential building block of any multimedia video conferencing system. It reduces the bandwidth requirements of the underlying network transport service and helps to maintain an acceptable end-to-end delay for audio.

HomeMeeting Inc. provides complete Internet service (www.homemeeting.com) for multipoint multimedia IP-communication network. To the best of our knowledge, this is the first attempt of fully Internet-based interactive multipoint multimedia WAN communication service with enhanced quality of service (QoS) and a complete suite of presentation/discussion functionalities over narrowband (as low as 26.4 Kbps) connections. Every registered member of this service can sign into the Member Meeting Center from HomeMeeting's website, schedule meeting, invite meeting participants, and pre-upload documents for online discussion. To avoid the need of multiple microphone requirement which is feasible for most low-end audio/video conferencing terminals, and to avoid the need of using very complex signal processing algorithms which call for higher computational needs and longer voice delay, in this invention, a low complexity and effective silence detection technique based on an intelligent determination of adaptive threshold value is proposed to enable real-time audio/video conferencing.

### PRIOR ART

The issue of silence detection has been explored since digital speech processing research was initiated more than 40 years ago [1]. The use of energy levels and/or zero crossing rates for silence detection can be satisfactory only at high signal-to-noise ratios. A wide variety of approaches have been proposed, from the simplest form based on comparing the signal magnitude with a pre-specified threshold which results in poor performance in the presence of background noise and varying magnitudes, to very sophisticated algorithm, such as the use of third-order statistics to exploit the non-linearity of speech characteristics at the changeovers of speech and silence [2] which is too complex, particularly for real-time software based implementation on general purpose computers.

Based on the short-term energy and zero-crossing measures of speech signals, a low complexity, while less effective and less flexible, silence detection algorithm was proposed in [3]. More specifically, the pre-specified Eₜₕᵣₑₛₕ can be determined as follows:

I₁=0.03(Eₘₐₓ−Eₘᵢₙ)+Eₘᵢₙ

I₂=4Eₘᵢₙ

Eₜₕᵣₑₛₕ=5×min(I₁,I₂)

where Eₘₐₓ and Eₘᵢₙ are the maximum and minimum energy values (sum of squared magnitudes over certain interval of time, e.g., 10 msec) estimated over entire speech interval.

A somewhat more complex algorithm, adopted in ITU G.729 Annex B [4], uses the degree of periodicity in signals to determine the presence of voice. However, it is not very effective in a conference call environment where several people may speak at the same time, and its computational requirement makes it harder to implement for a real-time application using low-end hardware devices (such as handheld PDAs). Another attempt is made by IC Tech. Inc. [5], which specifically combats the silence detection problem in noisy environment, especially when the distance between the microphone and the user's lips is varying, using a proprietary voice extraction (VE) technique which is achieved by exploiting inter-microphone differential information and the statistical properties of independent signal sources. This technique requires the use of multiple (at least two) microphones for recording mixtures of sound sources, which are then processed to separate out a single voice signal of interest from the mixture. For low-end audio/video conferencing terminals, the requirement of multiple microphones is never a feasible alternative.

### OBJECTS AND ADVANTAGES

This invention proposed a low complexity and effective silence detection technique based on an intelligent determination of adaptive threshold value to enable real-time audio/video conferencing. More specifically, by appropriately low passing the speech signal to remove the less influential high-frequency component as well the DC component of speech for an effective calculation of speech magnitude, we can best measure the most important portion of uttered speech. Moreover, through our invented adaptive threshold determination scheme, the silence detection system can adaptively update the silence threshold value by incorporating the new background signal magnitude so as to dynamically detect the silence from the real speech.

### SUMMARY OF THE INVENTION

Thanks to the recent advances in audio/video compression, processor design, and communication network architecture, it is now quite feasible to implement multimedia communication applications (e.g., audio/video conferencing) using standard computing and networking facilities. This shift of multimedia communication equipment and services from dedicated systems to general purpose computers and packet-based communication networks has introduced a quite different operating environment and has prompted the reexamination of several key algorithms. Silence detection and removal is an essential building block of any multimedia video conferencing system. It reduces the bandwidth requirements of the underlying network transport service and helps to maintain an acceptable end-to-end delay for audio.

To avoid the need of multiple microphone requirement which is feasible for most low-end audio/video conferencing terminals, and to avoid the need of using very complex signal processing algorithms which call for higher computational needs and longer voice delay, in this invention, a low complexity and effective silence detection technique based on an intelligent determination of adaptive threshold value is proposed to enable real-time audio/video conferencing.

### DETAILED DESCRIPTION OF THE INVENTION

I. Measuring the Sound Wave Magnitude

To determine the magnitude of sound waves, the incoming speech data are first separated into non-overlapping frames for effective processing. Each frame consists of 1200 samples (i.e., 150 msec of speech under 8000 samples/sec input rate). The input sound data s(t) is first low-pass filtered to remove the high frequency components.

f(0)=s(0)×2,

f(t)=s(t−1)+s(t), 1≦t<1200

The DC component is then removed from f(t), and the absolute value is computed for each sample.

g(t)=|f(t)−\overline{f}|, 0≦t<1200,

where

$$\overline{f} = \frac{{\sum }_{i = 0}^{1199} f ( i )}{1200}$$

The magnitude of speech signal σ in this frame is defined by the equation.

$$σ = {\sum }_{i = 0}^{1199} \vert g ( i ) - \overline{m} \vert , where \overline{m} = \frac{{\sum }_{i = 0}^{1199} g ( i )}{1200}$$

If σ is smaller than a threshold value λ, this frame is determined to be a silent frame.

II. Determining the Adaptive Threshold Value

During the conferencing, the background environment changes along the time, the intensity of participants' speech also varies all the time due to the movement of heads (in case a fixed location microphone is used). The threshold value λ needs to be changed according to the environments. To change λ, a value d is computed for 8 consecutive frames.

$$d = {\sum }_{i = 0}^{7} \vert {σ}_{i} - \overline{σ} \vert ,$$

where

$$\overline{σ} = \frac{{\sum }_{i = 0}^{7} \vert {σ}_{i} \vert}{8} .$$

If d is greater than a pre-specified empirical constant k, then λ is not updated. If d is smaller, the source of the sound is determined from the background and λ is updated as a function of d and σₘₐₓ accordingly:

λ←λ+φ(d,σₘₐₓ),

where the function φ can be any general function. In our current implementation, a relatively simple function was chosen, i.e.,

$$\begin{matrix}λ ← λ + Δ if m \times {σ}_{max} > λ \\ λ ← λ - Δ if m \times {σ}_{max} \leq λ - 100 \\ λ ← λ else\end{matrix} \} if d < k$$

$${σ}_{max} = {{max}_{i = 0}}^{7} {σ}_{i}$$

where Δ is an empirical positive constant, m is another empirical constant with value greater than 1.

What is claimed is:

1. A low complexity and effective silence detection technique based on an intelligent determination of adaptive threshold value to enable real-time audio/video conferencing comprising:
a) means (framing of speech) to best measure the most important portion of uttered speech;
b) means (adaptive threshold determination) to adaptively update the silence threshold value by incorporating the new background signal magnitude.

2. The system of claim 1 further comprises techniques to low pass the speech signal so as to remove the less influential high-frequency component of speech for an effective calculation of speech magnitude.

3. The system of claim 1 further comprises techniques to remove the DC component of the speech signal, which is commonly microphone dependent, for an effective calculation of speech magnitude.

4. The system of claim 1 further comprises techniques to effectively measure the potential presence of speech by measuring the temporal variation of calculated speech magnitude.

5. The system of claim 1 further comprises techniques to update the silence threshold value by incorporating the temporal variations of speech magnitude.
